(19) United States
(12) Patent Application Publication
(10) Pub. No.: US 2012/0303937 A1
(43) Pub. Date: Nov. 29, 2012

(54) COMPUTER SYSTEM AND CONTROL METHOD THEREOF

(76) Inventors: Chia-I CHU, Taipei (TW); Cheng-Hsein Yang, Taipei (TW)

(21) Appl. No.: 13/479,542

(22) Filed: May 24, 2012

Related U.S. Application Data
(60) Provisional application No. 61/489,570, filed on May 24, 2011.

(51) Int. Cl. G06F 9/312

(52) U.S. Cl. 712/214; 712/E09.033

(57) ABSTRACT

A computer system used to execute an application includes a motion sensing unit, a processor and an instruction transfer unit. The motion sensing unit senses a gesture of a human body and generates an input instruction based on the gesture. The processor executes the application (or a game). The instruction transfer unit is connected with the motion sensing unit and the processor and serves as a communication interface between the motion sensing unit and the application. The instruction transfer unit transfers the input instruction to a control command, and the processor controls and executes the application in accordance with the control command.

### CROSS REFERENCE TO RELATED APPLICATIONS

The non-provisional patent application claims priority to U.S. provisional patent application with Ser. No. 61/489,570 filed on May 24, 2011. This and all other extrinsic materials discussed herein are incorporated by reference in their entirety.

### BACKGROUND OF THE INVENTION

1. Field of Invention

The disclosure relates to a computer system and a control method thereof.

2. Related Art

As the popularization and development of personal computers, the role of computers has been changed from simple operation platforms to multimedia entertainment platforms. Of course, various kinds of application for the computers are also created.

As shown in FIG. 1, the conventional application, such as a PC game, can be executed by the desktop computer 7 or laptop computer. When the user plays the game on the computer, the corresponding input device (e.g. the keyboard 71, controller or joystick) is necessary to control the PC game. For different games, the user must use the same device (including the keyboard 71, controller or joystick) to control the game. In other words, the user does not have other choice and must use these devices to play the game.

Therefore, it is an important subject to provide a computer system and control method thereof that allow the applications or games to be executed without rewriting or modifying the source code of the games or applications for different controls, thereby increasing the interaction between the user and the applications or games.

### SUMMARY OF THE INVENTION

The embodiment discloses a computer system, which is used to execute an application and comprises a motion sensing unit, a processor and an instruction transfer unit. The motion sensing unit generates an input instruction. The processor executes the application or game. The instruction transfer unit is connected with the motion sensing unit and the processor, and serves as a communication interface between the motion sensing unit and the application. The instruction transfer unit transfers the input instruction to a control command, and the processor controls and executes the application in accordance with the control command.

In one embodiment, the motion sensing unit senses a gesture of a user and generates the input instruction based on the gesture.

In one embodiment, the computer system further comprises a mode setting unit connected with the instruction transfer unit for setting a mode of the instruction transfer unit according to the type of the application or game.

In one embodiment, the mode setting unit is shown on a display device by a vision method.

In one embodiment, the instruction transfer unit contains a plurality of preset input instructions, so that it further determines whether the input instruction matches with one of the preset input instructions or not.

The embodiment also discloses a control method of a computer system, which is used to execute an application. The computer system comprises a motion sensing unit, a processor and an instruction transfer unit. The control method comprises: initiating the application; the instruction transfer unit receiving an input instruction generated by the motion sensing unit; the instruction transfer unit determining whether the input instruction matches with one of a plurality of preset input instructions; if the input instruction matches with one of the preset input instructions, the instruction transfer unit transferring the input instruction to a control command; and the processor controlling and executing the application in accordance with the control command.

In one embodiment, the control method further comprises: a mode setting unit setting a mode of the instruction transfer unit according to the type of the application.

In one embodiment, the control method further comprises: the motion sensing unit detecting a gesture of a user and generating the input instruction based on the gesture.

As mentioned above, the computer system of the invention is used to execute the application, and has an instruction transfer unit for serving as a communication interface between a motion sensing unit and the application. The motion sensing unit senses a gesture of a user and generates the input instruction based on the gesture. The instruction transfer unit receives the input instruction and determines whether the input instruction matches with one of the plurality preset input instructions or not. If the input instruction matches with one of the plurality preset input instructions, the instruction transfer unit transfers the input instruction to a control command, which is used to control the application. In other words, the user can express different gestures to control different applications, which must be performed by using keyboard or joystick in the conventional art. Accordingly, in the invention, it is unnecessary to rewrite or modify the source code of the application for providing different operation modes of the application, and it is possible to increase the interaction between the user and the application through the settings of the instruction transfer unit.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing the conventional control method of the application;

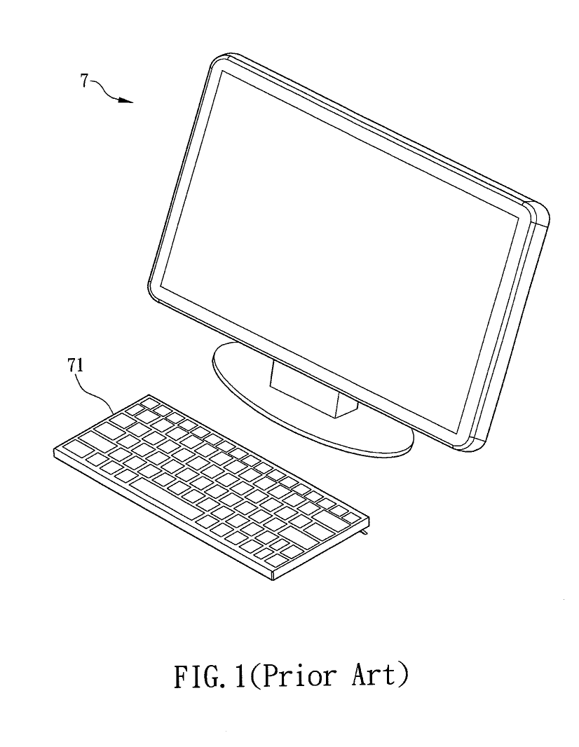

FIG. 2 is a schematic diagram of a computer system according to an embodiment of the invention;

FIG. 3 is a schematic diagram of a computer system according to another embodiment of the invention;

FIG. 4 is a flow chart of a control method of a computer system according to an embodiment of the invention; and

FIGS. 5A and 5B are schematic diagrams showing the dynamic control mode of the computer system.

### DETAILED DESCRIPTION OF THE INVENTION

A computer system and a control method thereof for controlling the application program without modifying the source code of the application are provided. For example, the novel control method is to use a motion detection unit to sense the gesture of human body instead of using the traditional keyboard or mouse, so that the user can perform the novel control method to control and execute the game. Accordingly, it is unnecessary to rewrite or modify the program, and is still possible to increase the interaction between the user and the application.

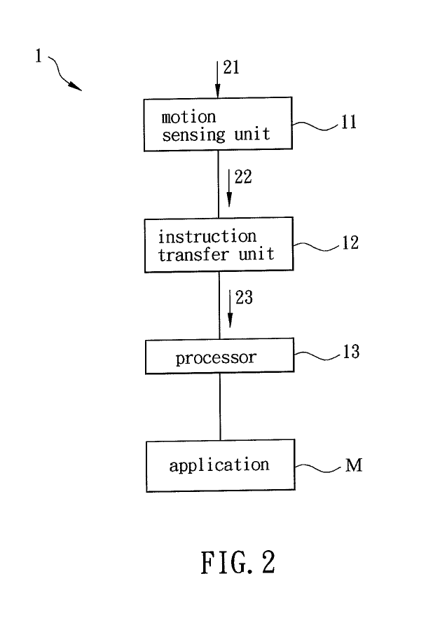

FIG. 2 is a schematic diagram of a computer system 1 according to an embodiment of the invention. The computer system 1 is used to execute an application M, such as a commercial PC game. In more detailed, the application M can be any application, computer game, or multimedia program that must be controlled by keyboard or joystick in conventional. Each application program has a corresponding preset control commands, so that the user can use the keyboard 71, controller or joystick to operate or input the control commands, thereby executing and controlling and playing the game. However, since different games usually have different designs, and each game may have individual preset control command(s). Thus, for different applications, the user must use the same way to control them, for example, by keyboard 71, controller or joystick.

When the game (application M) is executed on the computer system 1, the invention uses a motion sensor method to sense a gesture of a user, and then transfers the gesture to a corresponding control command for controlling the application. Thus, the user can directly control the game instead of through the keyboard or mouse, so that the conventional control method by keyboard and joystick can be replaced.

The computer system 1 of the embodiment is, for example, a desktop computer or a laptop computer. The computer system 1 includes a motion sensing unit 11, an instruction transfer unit 12, and a processor 13.

The motion sensing unit 11 senses or captures a gesture 21 of the user and generates an input instruction 22 according to the gesture 21. In this embodiment, the motion sensing unit 11 includes an image capturing device (video camera), which can be a build-in component or an extended component. The motion sensing unit 11 can capture the motion of human body such as waving hand, moving, jumping or the likes. Furthermore, it can dynamically capture the gesture of the human body and transfer to the corresponding input instruction, which is then inputted to the computer system 1.

The instruction transfer unit 12 is electrically connected with the motion sensing unit 11 for receiving the input instruction from the motion sensing unit 11. In this embodiment, the instruction transfer unit 12 is, for example, software (X-motion), which can transfer the input instruction and output the corresponding control command. Herein, each input instruction is corresponding to a certain control command.

The instruction transfer unit 12 receives the input instruction 22 from the motion sensing unit 11 and then determines whether the input instruction 22 matches with one of the preset input instructions or not. If it determines that the input instruction 22 matches with one of the preset input instructions, the instruction transfer unit 12 transfers the received input instruction 22 to a corresponding control command 23.

The processor 13 is electrically connected with the instruction transfer unit 12, and controls and operates the application M according to the control command 23. In this embodiment, the processor 13 is for example a CPU.

The instruction transfer unit 12 is connected with the motion sensing unit 11 and the processor 13, and serves as the communication interface between the motion sensing unit 11 and the application M. The motion sensing unit 11 captures and senses the motion of the user, and then the instruction transfer unit 12 transfers it to an instruction that is recognizable for the application M. After that, the processor 13 controls and operates the application M according to the transferred control command.

For example, the instruction transfer unit 12 can classify the application and transfer the corresponding instructions. In conventional design, the application can only recognize the preset control commands corresponding to the buttons of the mouse or the X-, Y- and Z-buttons of the keyboard. The user must input the control commands that are recognizable for the application so as to control the application program. In this embodiment, the instruction transfer unit 12 of the invention contains a plurality of preset control commands corresponding to the traditional X-, Y- and Z-buttons. These preset control commands of the invention are corresponding to the gestures sensed by the motion sensing unit. The recognizable gestures may include raising one hand, raising two hands, crossing hands, or the likes. Each of the gestures refers to one input instruction, and the input instruction can be transferred to a control command recognizable for the application after entering the instruction transfer unit 12. For example, the gesture of raising one hand is set to correspond to (a control command recognizable for the application as) the conventional X-button, and the gesture 21 of putting one hand down is set to correspond to a control command 23 of jump. Accordingly, the processor 13 inputs the control command 23 of jump to the application M so as to control the application M to generate the corresponding action.

When the motion sensing unit 11 senses or captures a gesture 21 of raising one hand from the user, it generates a corresponding input instruction 22 and transmits the input instruction 22 to the instruction transfer unit 12. In this invention, the instruction transfer unit 12 firstly determines whether the input instruction 22 matches with one of a plurality of preset input instructions or not. If it is determined that the input instruction 22 matches with one of the preset input instructions, the instruction transfer unit 12 outputs a control command 23 corresponding to the input instruction and then the processor 13 controls or operates the application M according to the control command 23.

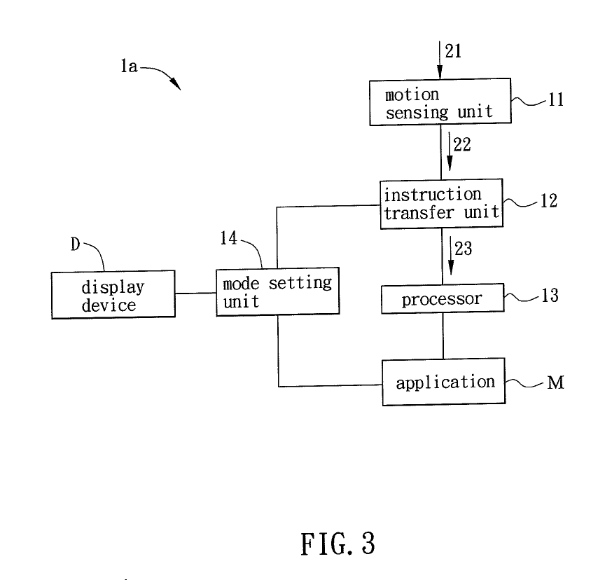

FIG. 3 is a schematic diagram of a computer system 1 a according to another embodiment of the invention. In this embodiment, the computer system la further includes a mode setting unit 14 connected with the instruction transfer unit 12, so that the computer system la can separately control the application programs in different types (e.g. ball games, shooting games or the likes).

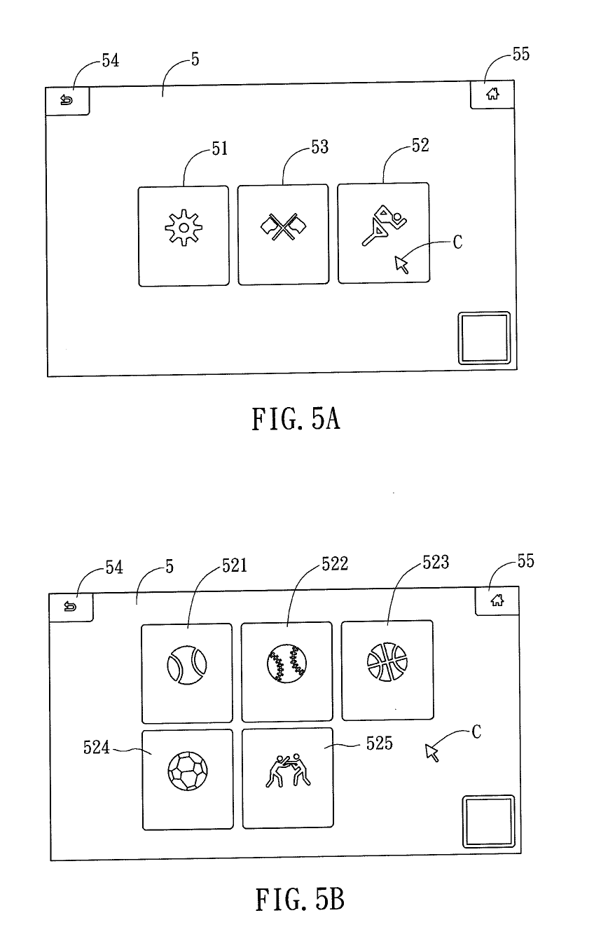

The mode setting unit 14 can set the transfer mode of the instruction transfer unit 12 according to the type of the application M, thereby setting the corresponding control commands. The type of the application M may be classified to sports and non-sport. When the user wants to operate the game software of different types, the instruction transfer unit 12 is switched to the control mode corresponding to the type of the application program. When the user wants to play a basketball game (e.g. NBA 2011) in the computer system, he/she can utilize the instruction transfer unit 12 of the embodiment to set the mode of this game before starting this game. Referring to FIG. 5A, the displayed screen 5 shows a common mode 51, a sport mode 52 and a racing mode 53. Besides, the manus of some dynamic control modes such as a return mode 54 located at the top-left corner and a home mode 55 located at the top-right corner are also configured. The motion sensing unit 11 can capture the gesture (or gesture position) of the user and show a cursor C on the displayed screen 5. The user can control the cursor C by his/her gesture to move the cursor C to a dynamic control mode displayed on the display device D. For example, the user may control the cursor C to overlap with the sport mode 52 for a period of time so as to select the sport mode 52 (with respect to the basketball game). Then, the instruction transfer unit 12 is changed to the sport mode 52 by switching the mode setting unit 14 and uses the sport mode 52 to correspondingly control the application program.

Referring to FIG. 5B, it is possible to select different sport types such as tennis mode 521, baseball mode 522, basketball mode 523, soccer mode 524, and fighting mode 525. The user can select the desired sport type following the same operation as mentioned above. Through different settings, the user can use proper gesture to control the game, so it is more convenient to the user. To be noted, the above-mentioned modes of the dynamic control mode are for illustrations only and are not to limit the invention.

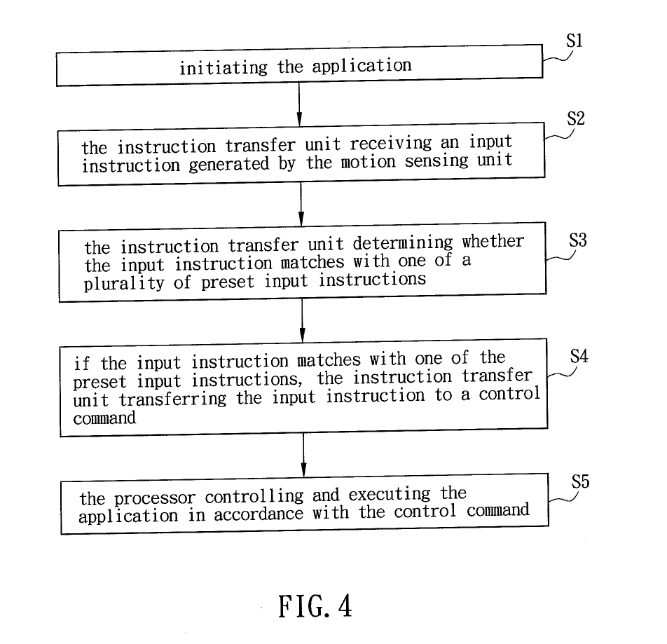

FIG. 4 is a flow chart of a control method of a computer system according to an embodiment of the invention, which includes steps S1 to S5. The step S1 is to initiate the application. In the step S2, the instruction transfer unit receives an input instruction generated by the motion sensing unit. In the step S3, the instruction transfer unit determines whether the input instruction matches with one of a plurality of preset input instructions. In the step S4, if the input instruction matches with one of the preset input instructions, the instruction transfer unit transfers the input instruction to a control command. In the step S5, the processor controls and executes the application in accordance with the control command.

The control method of a computer system of the invention will be further described hereinafter. As shown in FIGS. 3 and 4, in the step S1, the computer system 1a uses the processor 13 to initiate the application M, such as a PC game. After the step S1, the motion sensing unit 11 starts to sense or capture a gesture 21 of a user, and then determines whether to sense the gesture 21 of the user. Furthermore, if the motion sensing unit 11 determines that the gesture 21 of the user has been sensed, the motion sensing unit 11 then generates a corresponding input instruction 22 according to the gesture 21. Otherwise, if the motion sensing unit 11 determines that the gesture 21 of the user has not been sensed, it can repeat the above step again to sense or capture a gesture 21 of a user.

After the motion sensing unit 11 generates a corresponding input instruction according to the gesture of the user, the steps S2 and S3 are successively performed. In the steps S2 and S3, the instruction transfer unit 12 receives the input instruction 22 generated by the motion sensing unit 11, and determines whether the input instruction 22 matches with one of a plurality of preset input instructions. Herein, the instruction transfer unit 12 contains a plurality of preset input instructions and a plurality of control commands. The preset input instructions correspond to the control commands one by one. In the step S4, if the input instruction 22 matches with one of the preset input instructions, the instruction transfer unit 12 transfers the received input instruction 22 to a corresponding control command 23.

To be noted, before the step S2, the mode setting unit 14 may set the mode of the instruction transfer unit 12 according to the type of the application M. In more specific, the mode setting unit 14 of the embodiment can use the instruction transfer interface to set the mode of the control commands based on the type of the application M so as to transfer the input instruction to the corresponding control command. In this case, the application M can be, for example, any of the application, computer games, and other multimedia programs that are conventionally controlled by keyboard or joystick. In other words, the mode setting unit 14 can define the type of the instruction transfer unit 12 and the control commands 23 corresponding to the control mode and control signals of the original keyboard or joystick for the application M.

To be noted, the mode setting unit 14 can be operated manually or automatically. For example, the user or developer can manually set the instruction transfer unit 12 to a tennis mode for a tennis game (application M), or intentionally set it to other modes. Otherwise, the mode setting unit 14 may automatically recognize the type of the application M and then automatically set the corresponding mode.

In addition, the computer system of the invention can visualizedly set the mode of the instruction transfer unit 12 in the display device D. In order to determine the dynamic control mode selected by the user, the mode setting unit 14 can visualizedly set the mode of the instruction transfer unit 12 through a menu displayed on the display device D. Besides, if the selected mode of the user can be determined, the display device shows an error message. If the user can not be sensed, the step of sensing the user will be performed again. Moreover, the mode setting unit 14 may show some information on the display device D such as “Please move your body in front of the sensor.”

After the user has selected the mode of the instruction transfer unit 12, the application M is started. As the above-mentioned step S2, the instruction transfer unit 12 then receives the input instruction 22. In the step S3, the instruction transfer unit 12 determines whether the input instruction 22 matches with one of a plurality of preset input instructions. In the step S4, if the input instruction 22 matches with one of the preset input instructions, the instruction transfer unit 12 transfers the input instruction 22 to a control command 23. In the step S5, the processor 13 controls and executes the application M in accordance with the control command 23.

Therefore, the mode setting unit 14 does not directly control the application M by the gesture 21 but use the control signal 23 from the instruction transfer unit to control the application M. In the computer system 1, 1a and the control method thereof of the invention, it is unnecessary to rewrite or modify the program for providing different operation modes of the application M, and it is possible to set and control the application of different types by the instruction transfer unit 12.

In summary, the computer system of the invention is used to execute the application, and has an instruction transfer unit for serving as a communication interface between a motion sensing unit and the application. The motion sensing unit senses a gesture of a user and generates the input instruction based on the gesture. The instruction transfer unit receives the input instruction and determines whether the input instruction matches with one of plural preset input instructions or not. If the input instruction matches with one of the preset input instructions, the instruction transfer unit transfers the input instruction to a control command, which is used to control or operate the application. In other words, the user can express different gestures to control different application, which must be performed by using keyboard or joystick in the conventional art. Accordingly, in the invention, it is unnecessary to rewrite or modify the program for providing different operation modes of the application, and it is possible to increase the interaction between the user and the application through the settings of the instruction transfer unit.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A computer system, which is used to execute an application, comprising:
a motion sensing unit generating an input instruction;
a processor executing the application; and
an instruction transfer unit connected with the motion sensing unit and the processor and serving as a communication interface between the motion sensing unit and the application;
wherein, the instruction transfer unit transfers the input instruction to a control command, and the processor controls and executes the application in accordance with the control command.

2. The computer system of claim 1, wherein the motion sensing unit senses a gesture of a user and generates the input instruction based on the gesture.

3. The computer system of claim 1, further comprising:
a mode setting unit connected with the instruction transfer unit and setting a mode of the instruction transfer unit according to the type of the application.

4. The computer system of claim 3, wherein the mode setting unit is shown on a display device by a vision method.

5. The computer system of claim 1, wherein the instruction transfer unit contains a plurality of preset input instructions.

6. The computer system of claim 5, wherein the instruction transfer unit determines whether the input instruction matches with one of the preset input instructions or not.

7. A control method of a computer system, which is used to execute an application, wherein the computer system comprises a motion sensing unit, a processor and an instruction transfer unit, the control method comprising:
initiating the application;
the instruction transfer unit receiving an input instruction generated by the motion sensing unit;
the instruction transfer unit determining whether the input instruction matches with one of a plurality of preset input instructions;
if the input instruction matches with one of the preset input instructions, the instruction transfer unit transferring the input instruction to a control command; and
the processor controlling and executing the application in accordance with the control command.

8. The control method of claim 7, further comprising:
a mode setting unit setting a mode of the instruction transfer unit according to the type of the application.

9. The control method of claim 7, further comprising:
storing a plurality of the preset input instructions in the instruction transfer unit.

10. The control method of claim 7, further comprising:
the motion sensing unit detecting a gesture of a user and generating the input instruction based on the gesture.
